(19) United States
(12) Patent Application Publication
(10) Pub. No.: US 2009/0091825 A1
(43) Pub. Date: Apr. 9, 2009

(54) Plastic Polarized Lens

(75) Inventors: Toru Saito, Nagano-ken (JP); Toshihito Kanai, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/282,635

(22) PCT Filed: Apr. 25, 2007
(86) PCT No.: PCT/JP2007/059410

§ 371 Date: Sep. 11, 2008

(30) Foreign Application Priority Data
Apr. 27, 2006 (JP) 2006-123037
Mar. 1, 2007 (JP) 2007-051225

(51) Int. Cl. G02B 1/08; G02B 1/11; G02B 5/30

(52) U.S. Cl. 359/493; 252/585

(57) ABSTRACT

A plastic polarized lens 1 contains a lens substrate 2, which is obtained by curing through polymerization a polymerization composition having a refractive index of 1.60 or more containing a thiourethane polymerization composition or a thioepoxy polymerization composition, having embedded therein a polarized film 14, which is obtained by forming antireflection layers 14B having a five-layer structure of Al₂O₃ ZrO₂ accumulated alternately on both surfaces of a polarized film substrate 14A obtained by curving an iodine polarized film to a prescribed curvature, followed by cutting into a circular outer shape. According to the constitution, such a plastic polarized lens can be obtained that is reduced in reflection on the surface of the polarized film embedded in the polymerization composition and has good polarizing capability.

### TECHNICAL FILED

The present invention relates to a plastic polarized lens shielding light having a prescribed polarizing direction.

### BACKGROUND ART

A polarized lens shields light having a prescribed polarizing direction that is reflected from water surface or the like. The polarized lens is widely employed for such purposes as a lens of dark glasses and correcting glasses.

It has been known that the polarized lens includes such a plastic polarized lens that is obtained by adhering two lenses with a polarized film intervening therebetween, and such a plastic polarized lens that is obtained by injecting a raw material monomer around a polarized film, followed by being cured through polymerization, to embed the polarized film inside the lens. Among these, in recent years, the plastic polarized lens having a polarized film embedded inside the lens is becoming the mainstream from the standpoint mainly of durability including water resistance and weather resistance.

As a method for producing the plastic polarized lens, the following method has been proposed, for example, in JP-A-61-213114. A second rigid mold having a transfer surface is fixed by interfitting to a cylindrical elastic mold having a step for interfitting rigid molds thereinside, at a lower part of the step. A film member (polarized film) is placed on an upper part of the step, and a ring spacer is further placed thereon. A first rigid mold having a transfer surface is further placed and fixed on the spacer, and a resin monomer is then injected to the space, followed by being cured through polymerization.

The following method has been also proposed, for example, in JP-A-2005-234153. A dye polarized film formed of a polyvinyl alcohol resin containing a metallic compound and boric acid is embedded in or accumulated to a thiourethane polymerization composition (polymerization composition means that a composition be able to be polymerized), and the polymerization composition is cured to obtain a plastic polarized lens.

However, a plastic polarized lens having a polarized film embedded inside the lens suffers distortion of the polarized film associated with heating and polymerization contraction upon curing the polymerization composition (which includes the aforementioned resin monomer) through polymerization by heating. The term “distortion” referred herein means such a state that the polarized film is deformed.

As a result of the distortion, such an appearance problem arises that the surface of the polarized film is viewed as distorted upon reflection. In the case where the polymerization composition provides by curing through polymerization a lens base material having a high refractive index of 1.60 or more, particularly, the surface of the polarized film is easily viewed upon reflection owing to the large difference in refractive index from the polarized film, which brings about a problem of the distortion of the surface of the polarized film becoming remarkable. A polarized lens constituted by adhering two lenses with a polarized film intervening therebetween also suffers such a problem that reflection on the surface of the polarized film becomes remarkable due to the large difference in refractive index from the polarized film although it suffers small distortion. In general, polarized films that are commercially available have a refractive index about from 1.47 to 1.50.

FIG. 3 is a photograph showing an example of reflection on a surface of a polarized film of a conventional plastic polarized lens, in which a waved reflected image of fluorescent bulbs on the surface of the polarized film is conspicuously viewed. The photograph shown in FIG. 3 is a reflected image of fluorescent bulbs obtained on a concave surface of a plastic polarized lens having a polarized film having a refractive index of 1.47 embedded in a polymerization composition having a refractive index of 1.67, in a dark box.

An object of the invention is to provide such a plastic polarized lens having excellent appearance that is suppressed in reflection on a surface of a polarized film embedded in or adhered to a polymerization composition.

### DISCLOSURE OF THE INVENTION

In order to attain the above and other objects of the invention, the invention relates to, in one embodiment, a plastic polarized lens containing a pair of plastic substrates disposed opposite to each other that contain a polymerization composition cured through polymerization, and a polarized film intervening between the plastic substrates, the plastic substrates having a refractive index of 1.60 or more, and the polarized film having an antireflection layer on at least one surface of surfaces in contact with the plastic substrates.

According to the embodiment, the polarized film embedded in or adhered to the polymerization composition having a refractive index of 1.60 or more has, on at least one surface of the surfaces thereof in contact with the plastic substrates, the antireflection layer having a function of suppressing reflection between the plastic substrate (lens substrate) and the polarized film, whereby such a plastic polarized lens having excellent appearance is obtained that is suppressed in reflection on the surface of the polarized film embedded in the polymerization composition even though the polymerization composition has a high refractive index, and the polarized film suffers distortion due to heat or contraction upon curing the polymerization composition.

In a preferred embodiment of the plastic polarized lens of the invention, the antireflection layer is an inorganic antireflection layer.

According to the embodiment, the antireflection layer formed on at least one surface of the surfaces of the polarized film in contact with the plastic substrates is an inorganic antireflection layer, whereby an antireflection layer having a multi-layer structure can be easily obtained, and an optimum film constitution can be obtained appropriate to the refractive index of the plastic substrates. Accordingly, even in the case where the polarized film suffers distortion due to heat or contraction upon curing the polymerization composition, reflection on the surface of the polarized film embedded in the polymerization composition is suppressed to provide a plastic polarized lens having excellent appearance.

In another preferred embodiment of the plastic polarized lens of the invention, the antireflection layer is an organic antireflection layer. It is also preferred that the organic antireflection layer is a single layer film containing a composition containing an organosilicon compound and inorganic oxide fine particles.

According to the embodiment, the antireflection layer formed on at least one surface of the surfaces of the polarized film in contact with the plastic substrates is an organic antireflection layer, whereby the antireflection film can be conveniently formed as a coated layer by a wet method, such as a dipping method and a spinning method, without any large-size equipment, such as a vacuum equipment. In the case where the organic antireflection layer is formed with a composition containing an organosilicon compound and inorganic oxide fine particles, the refractive index thereof can be controlled over a wide range even with a single layer film, and thus can be optimized appropriate to the refractive index of the plastic substrates. Accordingly, even in the case where the polarized film suffers distortion due to heat or contraction upon curing the polymerization composition, reflection on the surface of the polarized film embedded in the polymerization composition is suppressed to provide a plastic polarized lens having excellent appearance.

In still another preferred embodiment of the plastic polarized lens of the invention, the polymerization composition is a thiourethane polymerization composition containing a compound having at least two mercapto groups in one molecule and a compound having at least two iso(thio)cyanate groups in one molecule.

According to the embodiment, the polymerization composition is a thiourethane polymerization composition, whereby the lens substrates after curing can have a high refractive index of about from 1.60 to 1.70. Furthermore, since the polarized film embedded in or adhered to the polymerization composition has, on at least one surface of the surfaces thereof in contact with the polymerization composition, the antireflection layer appropriate to the polymerization composition, reflection on the surface of the polarized film can be suppressed. Accordingly, distortion of the polarized film, even though it occurs, can be prevented from becoming conspicuous. Consequently, such a plastic polarized lens can be obtained that is suppressed in reflection on the surface of the polarized film, has excellent appearance, has a small lens thickness, and can be reduced in weight.

In still another preferred embodiment of the plastic polarized lens of the invention, the polymerization composition is a thioepoxy polymerization composition containing a compound having at least two thioepoxy groups in one molecule.

According to the embodiment, the polymerization composition is a thioepoxy polymerization composition, whereby the lens substrates after curing can have a high refractive index of about from 1.70 to 1.76. Furthermore, since the polarized film embedded in or adhered to the polymerization composition has, on at least one surface of the surfaces thereof in contact with the polymerization composition, the antireflection layer appropriate to the polymerization composition, reflection on the surface of the polarized film can be suppressed. Accordingly, distortion of the polarized film, even though it occurs, can be prevented from becoming conspicuous. Consequently, such a plastic polarized lens can be obtained that is suppressed in reflection on the surface of the polarized film, has excellent appearance, has a small lens thickness, and can be reduced in weight.

### BRIEF DESCRIPTION OF THE DRAWINGS

FIG. 1 is a schematic cross sectional view of a lens mold for molding a lens.

FIG. 2 is a schematic cross sectional view of a plastic polarized lens thus molded.

FIG. 3 is a photograph showing an example of reflection on a surface of a polarized film of a conventional plastic polarized lens.

### BEST MODE FOR CARRYING OUT THE INVENTION

Embodiments of the invention will be described below.

A method for producing the plastic polarized lens will be described. The method for producing the plastic polarized lens of the invention may be any known method of embedding a polarized film in a polymerization composition. In this embodiment, such an example is described that a polarized film is embedded in a polymerization composition having a refractive index of 1.60 or more, and then the polymerization composition is cured to produce a plastic polarized lens.

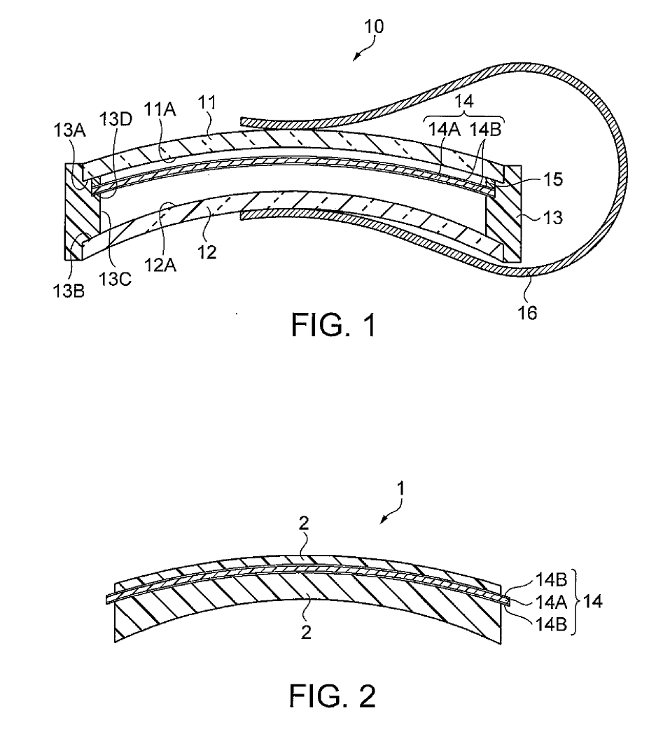

FIG. 1 is a schematic cross sectional view of a lens mold for molding the plastic polarized lens. FIG. 2 is a schematic cross sectional view of the plastic polarized lens thus molded.

In FIG. 1, the lens forming mold 10 for molding the plastic polarized lens has a pair of lens molds 11 and 12, a gasket 13, a polarized film 14, a holding ring 15 and a clamp 16.

The pair of lens molds 11 and 12 are each a member having a substantially discotic shape. The lens mold 11 has a concave surface 11A on the inner surface thereof, which faces the lens mold 12. The lens mold 11 is a mold for forming the convex surface of the lens. The lens mold 12 has a convex surface 12A on the inner surface thereof, which faces the lens mold 11. The lens mold 12 is a mold for forming the concave surface of the lens.

The gasket 13 is formed with synthetic rubber, an ethylene-vinyl acetate copolymer or the like, and has a substantially cylindrical shape. On one opening of the substantially cylindrical shape, a step 13A is provided, to which the lens mold 11 is to be interfitted. On the other opening of the substantially cylindrical shape, a step 13B is provided, to which the lens mold 12 is to be interfitted. On the inner surface 13C of the side wall between the step 13A and the step 13B, a mount 13D is provided, on which a periphery of a polarized film 14 described later is placed, and the holding ring 15 is placed.

The step 13A is provided at such a position that a prescribed distance is formed between the concave surface 11A of the lens mold 11 interfitted to the step 13A and the polarized film 14 placed on the mount 13D. The step 13B is formed at such a position that a prescribed distance is formed between the convex surface 12A of the lens mold 12 interfitted to the step 13B and the concave surface 11A of the lens mold 11 interfitted to the step 13A.

An injection hole (which is not shown in the figure) for injecting the polymerization composition is formed at the side wall of the gasket 13 between the step 13A and the step 13B. The inner wall 13C is an area that forms the outer shape of the plastic polarized lens, which is formed later by curing the polymerization composition injected into the lens forming mold 10 through polymerization, and has an inner diameter of about 70 mm.

The polarized film 14 contains a polarized film substrate 14A having on both surfaces thereof (both the convex surface side and concave surface side) antireflection layers 14B. The polarized film substrate 14A is a substrate having a film form obtained by curving a commercially available iodine polarized film by press molding, vacuum molding or the like to have a prescribed curvature, and then cutting the film to a circular shape. The polarized film substrate 14A preferably has a thickness of about 10 to 500 μm. In the case where the thickness is less than 10 μm, the film tends to be difficult to be handled due to the small rigidity. In the case where the thickness exceeds 500 μm, the prescribed curvature tends to be difficult to obtain upon curving the film.

The iodine polarized film used as the polarized film substrate 14A is a film substrate obtained in such a manner that polyvinyl alcohol (PVA) impregnated with iodine is formed into a film, which is then uniaxially stretched, and triacetyl cellulose (TAC) is accumulated as protective layers on both surfaces of the film. A polarized film obtained by using a dichroic dye instead of iodine may also be used. A polarized film obtained by using polyethylene terephthalate (PET) as the substrate instead of PVA may also be used. In this case, there are many cases where the protective layers of TAC may be omitted. The polarized film substrate 14A generally has a refractive index of about from 1.47 to 1.50.

Upon curving the polarized film substrate 14A, the polarized film substrate 14A is heated for curving. The heating temperature is preferably from 50 to 200° C., and more preferably from 80 to 150° C.

The curvature obtained by curving the film is substantially identical to the curvature of the concave surface 11A of the lens mold 11, and the film is formed substantially along the concave surface 11A of the lens mold 11. The outer shape of the polarized film substrate 14A having a circular shape is such a value that the outer diameter is larger than the outer diameter of the lens to be produced (about 70 mm), and the periphery of the film can be placed on the mount 13D of the gasket 13.

The antireflection layers 14B are formed on both surfaces of the polarized film substrate 14A. Some products corresponding to the polarized film substrate 14A are commercially available in the state where an antireflection layer is formed thereon. However, the antireflection layers of the commercially available products are designed for reducing reflection between air (having a refractive index of 1.00) and the polarized film. On the other hand, the polarized film 14 of this embodiment intends to reduce reflection on the surface of the polarized film 14 embedded in the lens substrate (polymerization composition having been cured through polymerization) as the plastic substrate having a refractive index of 1.60 or more, and therefore, it is necessary to design the antireflection layer 14B between the lens substrate and the polarized film 14.

As examples of the design of the antireflection layer 14B, four examples, i.e., antireflection layers A, B, C and D, are shown below.

The antireflection layers A, B, C and D are produced by forming a thin film having a constant refractive index in a single layer or multi-layer structure on a polarized film. The method for forming the antireflection layer is not limited and may be any method. Examples of the method include a dry method, such as a vacuum deposition method, a sputtering method, an ion plating method and a chemical vapor deposition (CVD) method, and a wet method. Among these, a vacuum deposition method is preferably used for forming the antireflection layers A, B and C. A wet method is preferably used for forming the antireflection layer D.

### Antireflection Layer A

The antireflection layer A is formed between the lens substrate (polymerization composition having been cured through polymerization) having a refractive index of 1.67 and the polarized film having a refractive index of 1.47. The antireflection layer A has a multi-layer structure containing plural layers of Al₂O₃ having a refractive index of 1.63 and ZrO₂ having a refractive index of 1.99 accumulated alternately.

The film structure of the antireflection layer A designed for a center wavelength λ of 510 nm contains the following five layers in the order from the surface of the polarized film substrate 14A.

First layer: Al₂O₃ layer with optical thickness of 0.25λ
Second layer: ZrO₂ layer with optical thickness of 0.55λ
Third layer: Al₂O₃ layer with optical thickness of 0.10λ
Fourth layer: ZrO₂ layer with optical thickness of 0.07λ
Fifth layer: Al₂O₃ layer with optical thickness of 0.11λ

The physical thickness of the layers is 76.6 nm for the first layer, 140.6 nm for the second layer, 32.1 nm for the third layer, 17.9 nm for the fourth layer, and 35.2 nm for the fifth layer.

### Antireflection Layer B

The antireflection layer B is formed between the lens substrate (polymerization composition having been cured through polymerization) having a refractive index of 1.67 and the polarized film having a refractive index of 1.47. The antireflection layer B has a two-layer structure containing a layer of Al₂O₃ having a refractive index of 1.63 and a layer of ZrO₂ having a refractive index of 1.99 accumulated on each other.

The film structure of the antireflection layer B designed for a center wavelength λ of 650 nm contains the first layer of Al₂O₃ having an optical thickness of 0.25λ and the second layer of ZrO₂ having an optical thickness of 0.03λ. The physical thickness of the layers is 100.5 nm for the first layer and 9.9 nm for the second layer.

### Antireflection Layer C

The antireflection layer C is formed between the lens substrate (polymerization composition having been cured through polymerization) having a refractive index of 1.74 and the polarized film having a refractive index of 1.47. The antireflection layer C has a multi-layer structure containing plural layers of Al₂O₃ having a refractive index of 1.63 and ZrO₂ having a refractive index of 1.99 accumulated alternately.

The film structure of the antireflection layer C designed for a center wavelength λ of 510 nm contains the following five layers in the order from the surface of the polarized film substrate 14A.

First layer. Al₂O₃ layer with optical thickness of 0.25λ
Second layer: ZrO₂ layer with optical thickness of 0.55λ
Third layer: Al₂O₃ layer with optical thickness of 0.10λ
Fourth layer: ZrO₂ layer with optical thickness of 0.09λ
Fifth layer: Al₂O₃ layer with optical thickness of 0.11λ

The physical thickness of the layers is 76.6 nm for the first layer, 140.6 nm for the second layer, 31.3 nm for the third layer, 22.4 nm for the fourth layer, and 35.2 nm for the fifth layer.

### Antireflection Layer D

The antireflection layer D is formed between the lens substrate (polymerization composition having been cured through polymerization) having a refractive index of 1.67 and the polarized film substrate 14A having a refractive index of 1.47. The antireflection layer D contains a single layer having a refractive index of 1.57 containing an organosilicon compound and inorganic oxide fine particles.

The film structure of the antireflection layer D designed for a center wavelength λ of 510 nm is formed as a single layer having a refractive index of 1.57 and an optical thickness of 0.25% on the surface of the polarized film substrate 14A. The single layer having a refractive index of 1.57 is formed by coating a coating composition containing an organosilicon compound and inorganic oxide fine particles on the surface of the polarized film.

Preferred examples of the organosilicon compound include the compound represented by the following general formula (1):

R¹R²ₙSiX¹₃₋ₙ (1)

In the general formula (1), R¹ represents an organic group having a polymerizable reactive group. Specific examples of the polymerizable reactive group include a vinyl group, an allyl group, an acrylate group, a methacrylate group, an epoxy group, a mercapto group, a cyano group and an amino group.

R² represents a hydrocarbon group having from 1 to 6 carbon atoms. Specific examples of R² include a methyl group, an ethyl group, a butyl group, a vinyl group and a phenyl group. X¹ represents a functional group capable of being hydrolyzed (hydrolyzable group). Specific examples of the hydrolyzable group include an alkoxy group, such as a methoxy group, an ethoxy group and a methoxyethoxy group, a halogen group, such as a chloro group and a bromo group, and an acyloxy group. Numeral n is 0 or 1.

Specific examples of the organosilicon compound represented by the general formula (1) include vinyltrialkoxysilane, vinyltrichlorosilane, vinyltri(β-methoxyethoxy)silane, allyltrialkoxysilane, acryloxypropyltrialkoxysilane, methacyloxypropyltrialkoxysilane, methacryloxypropyldialkoxymethylsilane, γ-glycidoxypropyltrialkoxysilane, β-(3,4-epoxycyclohexyl)-ethyltrialkoxysilane, mercaptopropyltrialkoxysilane, γ-amonopropyltrialkoxysilane and N-β-(aminoethyl)-γ-aminopropylmethyldialkoxysilane.

These organosilicon compounds may be used as a mixture of two or more kinds thereof. It is more effective that the organosilicon compound is used after subjecting to hydrolysis.

The mixing amount of the organosilicon compound in the coating composition is preferably from 10 to 70% by weight, and more preferably from 20 to 60% by weight, based on the total solid content. In the case where the mixing amount is too small, the adhesion property between the antireflection layer D and the polarized film substrate 14A or between the antireflection layer D and the lens substrate tends to be insufficient after curing. In the case where the mixing amount is too large, cracks tend to occur in the antireflection layer D after curing.

Preferred examples of the inorganic fine particles include composite fine particles containing plural kinds of inorganic oxides. Examples of the composite fine particles include composite fine particles constituted by two or more kinds of inorganic oxides selected from oxides of Si, Al, Sn, Sb, Ta, Ce, La, Fe, Zn, W, Zr, In, Ti and the like.

Composite fine particles constituted by three or more kinds of inorganic oxides selected from oxides of Si, Sn, Sb, Zr and Ti are preferably used. Specific examples thereof include three-component composite fine particles containing titanium dioxide, zirconium dioxide and silicon dioxide, and three-component composite fine particles containing titanium dioxide, silicon dioxide and tin dioxide.

The composite fine particles may be those commercially available in the form of sol dispersed in a colloid form in water, an organic solvent, such as an alcohol, or other organic solvents. The average particle diameter of the composite fine particles is preferably in a range of from 1 to 100 nm, and more preferably from 5 to 30 nm.

There are many modes of composite of the composite fine particles. For example, in one mode, fine particles, such as TiO₂ and ZrO₂, deteriorating surrounding organic substances upon receiving light are coated with SiO₂ having low activity, and in another mode, two or more kinds of metallic oxides form an oxide compound.

The composite fine particles containing a high refractive index component covered with a low activity component can have a high refractive index but can have a low activity. Accordingly, the antireflection layer D obtained by curing a coating composition containing such a kind of composite fine particles can be easily optimized in refractive index owing to the wide controllable range in refractive index thereof. Furthermore, the antireflection layer can be excellent in adhesion property to the polarized film substrate 14A and the lens substrate and in weather resistance. Thus, the composite fine particles are quite different in advantage from mixed fine particles obtained by simply mixing TiO₂ fine particles and SiO₂ fine particles.

The mixing amount of the inorganic oxide fine particles may be determined depending on the target refractive index and characteristics of the film and is preferably from 5 to 80% by weight, and more preferably from 10 to 50% by weight, based on the solid content in the coating composition. In the case where the mixing amount is too small, the refractive index of the antireflection layer D after curing tends to be low to fail to obtain an optimum refractive index. In the case where the mixing amount is too large, cracks tend to occur in the antireflection layer after curing.

The coating composition may contain an organic compound having a polymerizable functional group, such as a polyfunctional epoxy compound and a (meth)acrylate compound, in addition to the organosilicon compound and the inorganic oxide fine particles. In particular, the addition of a polyfunctional epoxy compound has a high function of suppressing cracks from occurring in the antireflection layer D after curing.

The coating composition may further contain depending on necessity a curing catalyst, a surfactant, an antistatic agent, an ultraviolet ray absorbent, an antioxidant, a light stabilizer, a dispersion dye, an oil soluble dye, a pigment and the like, in addition to the aforementioned component, so as to improve the coating property of the coating composition and the quality of the antireflection layer D after curing.

In the case where the antireflection layer D is formed by using the coating composition containing the organosilicon compound and the inorganic oxide fine particles, the coating composition may be coated generally by using a wet method, such as a dipping method, a spinning method, a spraying method and a flowing method. Upon practicing the wet method, the coating composition may be diluted with a solvent, such as an alcohol, a ketone, an ester and an aromatic compound. The coating composition diluted with a solvent is coated on the polarized film substrate 14A, and then the coating composition thus coated is cured by heating or irradiation with an ultraviolet ray to form the antireflection layer D.

The antireflection layers A, B, C and D may be appropriately selected depending on the refractive index of the polymerization composition to be cured through polymerization, and formed on both surfaces of the polarized film 14 (polarized film substrate 14A), which has been curved to a prescribed curvature and formed into a circular shape.

In FIG. 1, the holding ring 15 is a ring member formed with synthetic rubber, an ethylene-vinyl acetate copolymer or the like, as similar to the gasket 13. The holding ring 15 is placed on the mount 13D to intervene between the polarized film 14 and the lens mold 11 forming the convex surface of the lens, thereby exerting a function of restricting the periphery of the polarized film 14 from moving.

The method for assembling the lens forming mold 10 will be described.

Upon assembling the lens forming mold 10, the polarized film 14, which has been curved and formed in outer shape, having the antireflection layer 14B appropriate to the refractive index of the polymerization composition is placed on the mount 13D formed on the inner wall 13C of the gasket 13. The convex surface of the polarized film 14 is directed to the opening of the gasket 13, and the periphery of the polarized film 14 is placed on the mount 13D. The holding ring 15 is then placed on the periphery of the polarized film 14 having been placed on the mount 13D.

The lens mold 11 is interfitted to the step 13A of the gasket 13 with the concave surface 11A thereof directed to the gasket 13. According to the operation, the polarized film 14 and the holding ring 15 are supported directed to the opening of the gasket 13, and the polarized film 14 and the concave surface 11A of the lens mold 11 are fixed with a prescribed distance. The prescribed distance at the center of the lens (i.e., the center of the lens mold 11) is generally about from 0.5 to 1.0 mm, and more preferably about from 0.5 to 0.8 mm.

The lens mold 12 is interfitted to the step 13B of the gasket 13 with the convex surface 12A thereof directed to the gasket 13. According to the operation, the convex surface 12A of the lens mold 12 is held with a prescribed distance to the concave surface 11A of the lens mold 11. The prescribed distance at the center of the lens (i.e., the center of the molding surfaces of the lens molds 11 and 12) may be generally about from 1.0 2.0 mm for a negative lens and about from 2.0 to 6.0 mm for a positive lens. In the case of a semifinished lens, the concave surface of which is to be subjected to processing to obtain prescribed curvature and thickness after forming the lens, the prescribed distance may be generally about from 5 to 10 mm.

The lens mold 11 and the lens mold 12 are then fixed by holding with the clamp 16 formed with an elastic material.

Consequently, the lens forming mold 10 is completed, which has the pair of lens molds 11 and 12 interfitted and the polarized film 14 intervening between the lens mold 11 and the lens mold 12. The lens forming mold 10 has a cavity surrounded by the lens mold 11, the gasket 13 and the polarized film 14, and a cavity surrounded by the lens mold 12, the gasket 13 and the polarized film 14.

Into the cavities of the lens forming mold 10 thus assembled, the polymerization composition as a raw material of the plastic lens is injected. The polymerization composition is injected by using an injection needle or the like through an injection hole provided in the gasket 13 between the step 13A and the step 13B. The polymerization composition thus injected is charged to the cavities on both concave and convex sides of the polarized film 14 disposed in the cavities.

The polymerization composition is preferably a composition containing a compound having a polyiso(thio)cyanate compound having at least two iso(thio)cyanate groups in one molecule and a polythiol compound having at least two mercapto groups in one molecule, or a composition containing a compound having at least two thioepoxy groups in one molecule.

Examples of the polyiso(thio)cyanate compound include a polyisocyanate compound and a polyisothiocyanate compound.

Specific examples of the polyisocyanate compound include an aliphatic polyisocyanate compound, such as hexamethylenediisocyanate, 2,2-dimethylpentanediisocyanate, 2,2,4-trimethylhexanediisocyanate, butenediisocyanate, 1,3-butadiene-1,4-diisocyanate, 2,4,4-trimethylhexamethylenediisocyanate, 1,6,11-undecanetriisocyanate, 1,3,6-hexamethylenetriisocyanate and bis(isocyanatoethyl)carbonate, an alicyclic polyisocyanate compound, such as isophoronediisocyanate, bis(isocyanatomethyl)cyclohexane, cyclohexanediisocyanate, methylcyclohexanediisocyanate, 4,4′-methylenebis(cyclohexylisocyanate), 4,4′-methylenebis(2-methylcyclohexylisocyanate), 2,5-bis(isocyanatomethyl)bicyclo-[2,2,1]-heptane, 4,8-bis(isocyanatomethyl)tricyclodecane and 4,9-bis(isocyanatomethyl)tricyclodecane, and an aromatic polyisocyanate compound, such as 1,2-diisocyanatobenzene, 1,3-diisocyanatobenzene, 1,4-diisocyanatobenzene, 2,4-diisocyanatotoluene, ethylphenylenediisocyanate, isopropylphenyldiisocyanate, dimethylphenylenediisocyanate, diethylphenylenediisocyanate, diisopropylphenylenediisocyanate, trimethylbenzenetriisocyanate, benzenetriisocyanate, biphenyldiisocyanate, toluidinediisocyanate, 4,4′-methylenebis(phenylisocyanate), 4,4′-methylenebis(2-methylphenylisocyanate), bibenzyl-4,4′-diisocyanate and bis(isocyanatophenyl)ethylene.

Specific examples of the polyisothiocyanate compound include an aliphatic polyisothiocyanate compound, such as 1,2-diisothiocyanatoethane and 1,6-diisothiocyanatohexane, an alicyclic polyisothiocyanate compound, such as cyclohexanediisothiocyanate, and an aromatic polyisothiocyanate compound, such as 1,2-diisothiocyanatobenzene, 1,3-diisothiocyanatobenzene, 1,4-diisothiocyanatobenzene, 2,4-diisothiocyanatotoluene, 2,5-diisothiocyanato-m-xylene, 4,4′-diisothiocyanatobiphenyl, 4,4′-methylenebis(phenylisothiocyanate), 4,4′-methylenebis(2-methylphenylisothiocyanate), 4,4′-methylenebis(3-methylphenylisothiocyanate), 4,4′-isopropylidenebis(phenylisothiocyanate), 4,4′-diisothiocyanatobenzophenone, 4,4′-diisothiocyanato-3,3′-dimethylbenzophenone and bis(4-isothiocyanatophenyl) ether.

Specific examples of the polythiol compound include an aliphatic polythiol compound, such as methanedithiol, ethanedithio, 1,1-propanedithiol, 1,2-propanedithiol, 1,3-propanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol, 2-methylcyclohexane-2,3-dithiol, 1,1-bis(mercaptomethyl)cyclohexane, thiomalic acid bis(2-mercaptoethyl ester), 2,3-dimercapto-1-propanol 2-mercaptoacetate, 2,3-dimercapto-1-propanol3-mercaptopropyonate, diethyleneglycolbis(2-mercaptoacetate), diethyleneglycolbis(3-mercaptopropyonate), 1,2-dimercaptopropylmethylether, 2,3-dimercaptopropylmethylether, 2,2-bis(mercaptomethyl)-1,3-propanedithiol, bis(2-mercaptoethyl)ether, ethyleneglycolbis(2-mercaptoacetate), ethyleneglycolbis(3-mercaptopropionate), trimethylolpropanebis(2-mercaptoacetate), trimethylolpropanebis(3-mercaptopropionate), pentaerythritoltetrakis(2-mercaptoacetate), pentaerythritoltetrakis(3-mercaptopropionate) and tetrakis(mercaptomethyl)methane, an aromatic polythiol compound, such as 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(mercaptoethyl)benzene, 1,3-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, 2,5-tolenedithiol, 3,4-toluenedithiol, 1,3-di(p-methoxyphenyl)propane-2,2-dithiol, 1,3-diphenylpropane-2,2-dithiol, phenylmethane-1,1-dithiol and 2,4-di(p-mercaptophenyl)pentane, an aromatic polythiol compound having a sulfur atom other than the mercapto group, such as 1,2-bis(mercaptoethylthio)benzene, 1,3-bis(mercaptoethylthio)benzene, 1,4-bis(mercaptoethylthio)benzene, 1,2,3-tris(mercaptomethylthio)benzene, 1,2,4-tris(mercaptomethylthio)benzene, 1,3,5-tris(mercaptomethylthio)benzene, 1,2,3-tris(mercaptoethylthio)benzene, 1,2,4-tris(mercaptoethylthio)benzene, 1,3,5-tris(mercaptoethylthio)benzene and nuclear alkylated compounds of these compounds, and an aliphatic polythiol compound having a sulfur atom other than the mercapto group, such as bis(mercaptomethyl)sulfide, bis(mercaptoethyl)sulfide, bis(mercaptopropyl)sulfide, bis(2-mercaptoethylthio)methane, bis(3-mercaptopropylthio)methane, 1,2-bis(2-mercaptoethylthio)ethane, 1,2-bis(3-mercaptopropyl)ethane, 1,3-bis(2-mercaptoethylthio)propane, 1,3-bis(3-mercaptopropylthio)propane, 1,2,3-tris(2-mercaptoethylthio)propane, 1,2,3-tris(3-mercaptopropylthio)propane, 1,2-bis((2-mercaptoethyl)thio)-3-mercaptopropane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, tetrakis(2-mercaptoethylthiomethyl)methane, tetrakis(3-mercaptopropylthiomethyl)methane, bis(2,3-dimercaptopropyl)sulfide, bis(1,3-dimercaptopropyl)sulfide, 2,5-dimercapto-1,4-dithiane, 2,5-dimercaptomethyl-1,4-dithiane, 2,5-dimercaptomethyl-2,5-dimethyl-1,4-dithiane, bis(mercaptoethyl)disulfide and bis(mercaptopropyl)disulfide.

The compound having at least two thioepoxy groups in one molecule means a compound having at least two structures represented by the following formula (2) in one molecule:

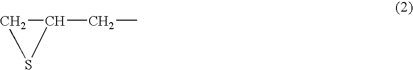

Specific examples of the compound having at least two thioepoxy groups in one molecule include bis(β-epithiopropyl) sulfide, bis(β-epidithiopropyl) sulfide, bis(β-epithiopropyl)disulfide, bis(β-epidithiopropyl)disulfide, bis(β-epithiopropyl)trisulfide, bis(β-epithiopropylthio)methane, 1,2-bis(β-epithiopropylthio)ethane, 1,3-bis(β-epithiopropylthio)propane, 1,2-bis(β-epithiopropylthio)propane, bis(epithioethyl)sulfide, bis(epithioethyl)disulfide, 1-(β-epithiopropylthio)-2-(β-epithiopropylthiomethyl)propane, 1,4-bis(β-epithiopropylthio)butane, 1,3-bis(β-epithiopropylthio)butane, 1-(β-epithiopropylthio)-3-(β-epithiopropylthiomethyl)butane, 1,5-bis(β-epithiopropylthio)pentane, 1-(β-epithiopropylthio)-4-(β-epithiopropylthiomethyl)pentane, 1,6-bis(β-epithiopropylthio)hexane, 1-(β-epithiopropylthio)-5-(β-epithiopropylthiomethyl)hexane, 1-(β-epithiopropylthio)-2-((2-β-epithiopropylthioethyl)thio)ethane, 1-(β-epithiopropylthio)-2-((2-(2-β-epithiopropylthioethyl)thioethyl)thio)ethane, tetrakis(β-epithiopropylthiomethyl)methane and 1,1,1-tris(β-epithiopropylthiomethyl)propane, a thioepoxy compound having an alicyclic skeleton, such as (1,3 or 1,4)-bis(β-epithiopropylthio)cyclohexane, (1,3 or 1,4)-bis(β-epithiopropylthiomethyl)cyclohexane, bis(4-(β-epithiopropylthio)cyclohexyl)methane, 2,2-bis(4-(β-epithiopropylthio)cyclohexyl)propane, (1,3 or 1,4)-bis(β-epithiopropylthio)benzene, (1,3 or 1,4)-bis(β-epithiopropylthiomethyl)benzene, bis(4-(β-epithiopropylthio)phenyl)methane and 2,2-bis(4-(β-epithiopropylthio)phenyl)propane, and a thioepoxy compound having an aromatic skeleton, such as (1, 3 or 1,4)-bis(β-epithiopropylthio)benzene and (1,3 or 1,4)-bis(β-epithiopropylthiomethyl)benzene.

In the polymerization composition, various substances, such as a polymerization catalyst, an ultraviolet ray absorbent, an antioxidant, a bluing agent and an internal releasing agent, may be added depending on necessity.

The lens forming mold 10 having the polymerization composition having been injected in the cavity is then subjected to curing (polymerization curing).

The polymerization curing is carried out by heating the lens forming mold 10. The lens forming mold 10 is placed in a polymerization oven (heating oven), and the temperature inside the oven is increased, for example, from about 20° C. to about from 120 to 130° C. over about 20 hours. According to the operation, the polymerization composition in the cavity is cured through polymerization.

The lens forming mold 10 having been subjected to polymerization curing is taken out from the polymerization oven, and after gradually cooling, the lens forming mold 10 is released. As a result of releasing the lens forming mold 10, shown in FIG. 2, production of the plastic polarized lens 1, which has the polarized film 14 embedded in the lens substrate (polymerization composition cured through polymerization) as the plastic substrate, is completed. The plastic polarized lens 1 thus molded is a meniscus lens having a convex surface and a concave surface as lens surfaces.

The plastic polarized lens 1 thus molded is then subjected to an annealing treatment by maintaining in an environment of about from 110 to 130° C. for about 2 hours.

A hardcoat layer and the like are then formed on the plastic polarized lens 1 depending on necessity. Examples of the hardcoat agent for forming the hardcoat layer include a silicone series, an acrylate series and a silazane series. The coating method is not particularly limited, and examples thereof include a spray coating method, a dip coating method, a flow coating method, a spin coating method and a bar coating method.

Before forming the hardcoat layer, a primer layer may be made intervene between the hardcoat layer and the surface of the plastic polarized lens 1. The impact resistance can be improved by providing the primer layer.

An antireflection layer may be provided depending on necessity. The antireflection layer may be provided by a dry method, such as a vacuum deposition method, a sputtering method, an ion plating method and a chemical vapor deposition (CVD) method, and a wet method. Among these, a vacuum deposition method is often used generally. Specifically, oxides of silicon, zirconium, titanium, niobium and the like, are formed into a multi-layer film having from 4 to 7 layers on the lens substrate or the hardcoat layer. An excellent antireflection effect can be obtained by providing the antireflection layer.

A water repellent film or a hydrophilic film may be formed depending on necessity. The water repellent film provides significant effect of preventing water marks and staining. The hydrophilic film can reduce fogging upon using the lens as glasses.

In the case where the plastic polarized lens 1 thus formed is a semifinished lens, the concave surface of the plastic polarized lens 1 is cut and/or polished to a prescribed curvature and thickness after forming the lens, and then the hardcoat layer and the antireflection layer are formed.

The embodiment of the invention will be described in more detail with reference to the following examples and comparative examples.

### EXAMPLE 1

### Preparation of Polymerization Composition

103 g of m-xylenediisocyanate as a polyisocyanate compound, 100 g of 4,8, or 4,7 or 5,7-dimercaptomethyl-1,11-dimercapto-3,6,9-trithiaundecane as a polythiol compound, 0.15 g of Zelec UN (a trade name, produced by Stepan Company) as an internal releasing agent, and 2.4 g of SEESORB 701 (a trade name, produced by Shipro Kasei Kaisha) as an ultraviolet ray absorbent were mixed and agitated for about one hour. Thereafter, 0.06 g of dibutyltindichloride as a polymerization catalyst was added and dissolved by agitating, and the mixture was degassed under vacuum of 5 mmHg for 60 minutes to prepare a polymerization composition of thiourethane plastics. Hereinafter, the polymerization composition thus produced is referred to as a polymerization composition PCA.

### Assemble of Lens Forming Mold

A commercially available iodine polarized film (having a refractive index of 1.47) was prepared as a polarized film substrate 14A, which was curved to a prescribed curvature and cut into a circular shape by pressing. In order to impart an antireflection function appropriate to the lens substrate (i.e., the polymerization composition cured through polymerization) 2 having a refractive index of 1.67, the antireflection layers A were formed on both surfaces of the polarized film substrate 14A by a vacuum deposition method to complete the polarized film 14.

A gasket 13, a lens mold 11 and a lens mold 12, which were appropriate to the plastic polarized lens 1 to be formed, were prepared.

The periphery of the polarized film 14 having the antireflection layer A was placed on a mount 13D of the gasket 13 with the convex surface of the polarized film 14 directed to the opening of the gasket 13, and a holding ring 15 was then placed on the periphery of the polarized film 14.

The lens mold 11 was interfitted to a step 13A of the gasket 13 with the concave surface 11A thereof directed to the gasket 13. The lens mold 12 was then interfitted to a step 13B of the gasket 13 with the convex surface 12A thereof directed to the gasket 13.

The lens mold 11 and the lens mold 12 were fixed by holding with the clamp 16. Consequently, assembling of the lens forming mold 10 was completed, which had the polarized film 14 intervening between the lens molds 11 and 12 in the gasket 13.

In the lens forming mold 10 thus assembled, the distance between the concave surface 11A of the lens mold 11 and the polarized film 14 at the center was 1.0 mm, and the distance between the concave surface 11A of the lens mold 11 and the convex surface 12A of the lens mold 12 at the center was 2.0 mm.

### Production of Plastic Polarized Lens

The polymerization composition PCA prepared was injected into the cavity of the lens forming mold 10 through an injection hole provided in the gasket 13. The lens forming mold 10 having the polymerization composition PCA having been injected was placed in a polymerization oven and heated from 25° C. to 120° C. over 20 hours to effect curing through polymerization.

The lens forming mold 10 taken out from the polymerization oven was released, and the plastic polarized lens 1 having the polarized film 14 embedded in the lens substrate 2 was subjected to an annealing treatment under an environment of about from 120° C. for about 2 hours. The plastic polarized lens 1 thus produced had a refractive index of 1.67.

### EXAMPLE 2

In Example 2, the preparation of the polymerization composition, the assembling of the lens forming mold, and the production of the plastic polarized lens were carried out in the same manner as in Example 1 except that a polarized film 14 having the antireflection layer B formed instead of the antireflection layer A was used. Accordingly, detailed description is omitted herein. The plastic polarized lens 1 thus produced had a refractive index of 1.67.

### EXAMPLE 3

In Example 3, a plastic polarized lens was produced by using a polymerization composition of thioepoxy plastics and a polarized film 14 having the antireflection layer C formed on the polarized film substrate 14A.

### Preparation of Polymerization Composition

90 g of bis(β-epithiopropyl)disulfide as a thioepoxy compound, 10 g of 4,8, or 4,7 or 5,7-dimercaptomethyl-1,11-dimercapto-3,6,9-trithiaundecane as a copolymerization component, and 1.0 g of SEESORB 701 (a trade name, produced by Shipro Kasei Kaisha) as an ultraviolet ray absorbent were mixed and completely dissolved by sufficiently agitating. Thereafter, 0.03 g of N,N-dimethylcyclohexylamine and 0.08 g of N,N-dicyclohexylmethylamine as a catalyst were added, and the mixture was sufficiently agitated at room temperature to obtain a uniform composition. The composition was degassed under reduced pressure of 5 mmHg for 30 minutes to prepare a polymerization composition of thioepoxy plastics. Hereinafter, the polymerization composition thus produced is referred to as a polymerization composition PCB.

Assemble of Lens Forming Mold

A commercially available iodine polarized film (having a refractive index of 1.47) was prepared as a polarized film substrate 14A, which was curved to a prescribed curvature and cut into a circular shape by pressing. In order to impart an antireflection function appropriate to the lens substrate (i.e., the polymerization composition cured through polymerization) 2 having a refractive index of 1.74, the antireflection layers C were formed on both surfaces of the polarized film substrate 14A by a vacuum deposition method to complete the polarized film 14.

### Production of Plastic Polarized Lens

The polymerization composition PCB prepared was injected into the cavity of the lens forming mold 10 through an injection hole provided in the gasket 13. The lens forming mold 10 having the polymerization composition PCA having been injected was placed in a polymerization oven and heated from 30° C. to 130° C. over 20 hours to effect curing through polymerization.

The lens forming mold 10 taken out from the polymerization oven was released, and the plastic polarized lens 1 having the polarized film 14 embedded in the lens substrate 2 was subjected to an annealing treatment under an environment of about from 130° C. for about 2 hours. The plastic polarized lens 1 thus produced had a refractive index of 1.74.

### EXAMPLE 4

In Example 4, the preparation of the polymerization composition, the assembling of the lens forming mold, and the production of the plastic polarized lens were carried out in the same manner as in Example 1 except that a polarized film 14 having the antireflection layer D formed instead of the antireflection layer A was used. Accordingly, only the method for forming the antireflection layer D (i.e., the preparation of the coating composition, and the coating and curing methods of the coating composition) will be described.

### Preparation of Coating Composition

100 g of propyleneglycolmonomethylether and 2.8 g of γ-glycidoxypropyltrimethoxysilane were mixed and sufficiently agitated to obtain a uniform solution. 0.8 g of a 0.1 N hydrochloricacid aqueous solution was added dropwise to the mixed solution under agitating. After agitating at room temperature for 4 hours, the solution was aged in a refrigerator over one day. 2.8 g of a composite fine particle sol containing titaniumdioxide, tindioxide and silicondioxide dispersed in methanol (a trade name, Optolake 1120Z 8RS-25•A17, produced by Catalysts & Chemicals Industries Co., Ltd.) was mixed with the mixed solution, which was then sufficiently agitated. Furthermore, 0.1 g of Fe(III) acetylacetonate as a catalyst was added to the mixed solution, which was then agitated at room temperature for 3 hours. The mixed solution was aged in a refrigerator over one day to prepare a coating composition. The coating composition thus prepared is referred to as a coating composition H1.

### Coating and Curing of Coating Composition

A commercially available iodine polarized film (having a refractive index of 1.47) was prepared as a polarized film substrate 14A, which was curved to a prescribed curvature and cut into a circular shape by pressing, in the same manner as in Example 1. Thereafter, the coating composition H1 was coated on the polarized film by a spin coating method (spinning condition: 1,800 rpm for 5 seconds) and heated to 80° C. for 150 minutes to cure the coated film. The operation was effected to both surfaces of the polarized film to form the antireflection layers D on both surfaces of the polarized film, whereby the polarized film 14 was completed. The antireflection layer D had a thickness of from 125 to 130 nm and a refractive index of 1.57.

The assembling of the lens forming mold and the production of a plastic polarized lens were carried out in the same manner as in Example 1 except that the polarized film 14 thus completed was used. The plastic polarized lens 1 thus produced had a refractive index of 1.67.

### COMPARATIVE EXAMPLE 1

In Comparative Example 1, the preparation of the polymerization composition, the assembling of the lens forming mold, and the production of the plastic polarized lens were carried out in the same manner as in Example 1 except that a commercially available iodine polarized film having no antireflection film (polarized film substrate 14A) was used as a polarized film 14. The plastic polarized lens 1 thus produced had a refractive index of 1.67.

### COMPARATIVE EXAMPLE 2

In Comparative Example 2, the preparation of the polymerization composition, the assembling of the lens forming mold, and the production of the plastic polarized lens were carried out in the same manner as in Example 1 except that a commercially available iodine polarized film having an antireflection layer having a refractive index of 1.00 (i.e., an antireflection layer appropriate to air) was used as a polarized film 14. The plastic polarized lens 1 thus produced had a refractive index of 1.67.

The plastic polarized lenses obtained in Examples 1 to 4 and Comparative Examples 1 and 2 were evaluated for appearance.

The method for evaluation was as follows. The plastic polarized lens 1 was placed in a dark box, and reflected images of fluorescent bulbs on the convex surface and the concave surface of the plastic polarized lens 1 were evaluated. The reflected appearance on the surface of the polarized film 14 was visually evaluated by the following four grades, AA, A, B and C.

AA: Substantially no reflection of the polarized film was observed.
A: Reflection of the polarized film was slightly observed, but no conspicuous distortion was found.
B: Reflection of the polarized film was observed, and distortion was found.
C: Reflection of the polarized film was clearly observed, and distortion was conspicuously found.

The results of evaluation for appearance are shown in Table 1 below.

TABLE 1

| | Refractive index | Antireflection layer | | Evaluation for |
|---|---|---|---|---|
| | of lens substrate | Name | Summary of layers | appearance |
| Example 1 | 1.67 | antireflection layer | inorganic | AA |
| | | A | five-layer film | |
| Example 2 | 1.67 | antireflection layer | inorganic | A |
| | | A | two-layer film | |
| Example 3 | 1.74 | antireflection layer | inorganic | AA |
| | | A | five-layer film | |
| Example 4 | 1.67 | antireflection layer | organic | AA |
| | | A | single layer film | |
| Comparative | 1.67 | none | — | C |
| Example 1 | | | | |
| Comparative | 1.67 | antireflection layer | — | C |
| Example 2 | | appropriate to air | | |

It was understood from the results shown in Table 1 that in the plastic polarized lenses 1 obtained in Examples 1 to 4, substantially no reflection was found on the surface of the polarized film 14 embedded in the lens substrate 2 on both the convex surface and the concave surface upon evaluation of reflected images of fluorescent bulbs to provide good appearance.

It is considered that this is because even in the case where the polymerization composition injected into the cavity of the lens forming mold 10 has a high refractive index of 1.60 or more, since the antireflection film 14B appropriate to the refractive index of the polymerization composition is formed on the surface of the polarized film 14 disposed inside the cavity, reflection on the surface of the polarized film 14 is reduced even though the polarized film 14 suffers distortion due to heat applied to the lens forming mold 10 or due to polymerization contraction upon curing the polymerization composition, whereby reflection on the surface of the polarized film 14 is difficultly viewed.

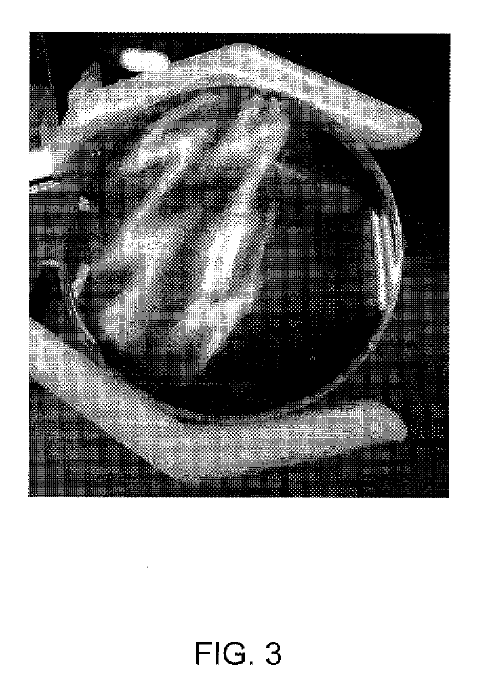

On the other hand, the plastic polarized lenses 1 obtained in Comparative Examples 1 and 2 were poor in appearance, in which distortion occurs on the surface of the polarized film 14 embedded in the lens substrate 2 on both the convex surface and the concave surface to provide appearance of waved reflected light (see FIG. 3).

The results are derived from such factors that an antireflection effect between the lens substrate and the polarized film is not obtained because a large difference in refractive index is formed between the polymerization composition injected in the cavity of the lens forming mold 10 and the polarized film substrate 14A, and/or the antireflection layer 14B formed between the polymerization composition and the polarized film substrate 14A has a film constitution that is appropriate for antireflection between the polarized film and air, whereby reflected light is clearly viewed from the surface of the polarized film 14 having been distorted upon polymerization curing.

As having been described, in the plastic polarized lens 1 of this embodiment, even in the case where the polymerization composition has a high refractive index of 1.60 or more, since the antireflection films 14B appropriate to the refractive index of the polymerization composition are formed on both surfaces (convex and concave surfaces) of the polarized film 14, which are in contact with the polymerization composition, embedded in the polymerization composition, reflection on the surface of the polarized film 14 is reduced even though the polarized film 14 suffers distortion upon curing the polymerization composition through polymerization, whereby distorted reflection on the surface of the polarized film 14 is difficultly viewed to provide a plastic polarized lens 1 having good appearance.

Furthermore, even in the case where the lens substrate 2 has a high refractive index of about from 1.60 to 1.70 by using a thiourethane polymerization composition or a high refractive index of about from 1.70 to 1.76 by using a thioepoxy polymerization composition, since the antireflection layers 14B appropriate to the polymerization composition are formed on both surfaces of the polarized film 14, which are in contact with the polymerization composition, embedded in the lens substrate 2, reflection on the surface of the polarized film 14 is prevented, and a plastic polarized lens 1 having a small lens thickness and a reduced weight can be obtained.

The plastic polarized lens 1 of this embodiment can be preferably used as a lens of dark glasses and correcting glasses. In addition, the plastic polarized lens 1 can be used as a polarized lens for a camera, a telescope and the like, and a cover glass for various clocks and watches.

The polarized film 14 has the antireflection layers on both surfaces of the polarized film substrate 14A in the aforementioned embodiment, but the antireflection layer may be formed on only one surface of the both surfaces of the polarized film substrate 14A. In the case where the antireflection layer is provided on only one surface, it is preferably formed on the side of the concave surface of the plastic polarized lens to be molded (i.e., on the side of the lens mold 12 for forming the concave surface of the lens). This is because in the case where distortion occurs, distortion of reflected light from a polarized film generally tends to be conspicuous on the concave surface as compared to the convex surface due to enlargement of images, and thus a problem in appearance tends to arise on the concave surface.

The antireflection layer formed on the polarized film substrate 14A of the polarized film 14 in this embodiment is the antireflection layers A, B, C and D having thin film having a constant refractive index formed into a single layer or multi-layer structure, but an antireflection layer of a so-called gradient film, in which the refractive index in the layer is changed, may be used instead of the thin film having a constant refractive index.

As a specific example of the gradient film, such a film may be applied to a polarized film 14 having a refractive index of 1.47 and a lens substrate 2 having a refractive index of 1.67 that the refractive index of the gradient film on the side in contact with the polarized film 14 is 1.47, which is gradually increased by leaving apart from the side in contact with the polarized film, so as to make the refractive index of the gradient film be 1.67 on the side in contact with the lens substrate 2.

In the embodiment, the plastic polarized lens 1 is obtained by embedding a polarized film having antireflection layers formed on both surfaces thereof in a polymerization composition having a refractive index of 1.60 or more, which is then cured through polymerization, but it is sufficient that the antireflection layer is provided between the polarized film 14 and the lens substrate 2. Accordingly, the same advantages can be obtained with a polarized lens obtained in such a manner that a polarized film 14 having antireflection layers on both surface thereof is held and adhered between two lens substrates 2 having been cured. It is also possible that antireflection layers are formed on the surfaces of the two lens substrates 2 on the side of the polarized film 14, and then the lens substrates 2 are adhered to the polarized film substrate 14A to produce the polarized lens 1.

1. A plastic polarized lens comprising a pair of plastic substrates disposed opposite to each other that contain a polymerization composition (polymerization composition means that a composition be able to be polymerized) cured through polymerization, and a polarized film intervening between the plastic substrates, the plastic substrates having a refractive index of 1.60 or more, and the polarized film having an antireflection layer on at least one surface of surfaces in contact with the plastic substrates.

2. The plastic polarized lens as claimed in claim 1, wherein the antireflection layer is an inorganic antireflection layer.

3. The plastic polarized lens as claimed in claim 1, wherein the antireflection layer is an organic antireflection layer.

4. The plastic polarized lens as claimed in claim 3, wherein the organic antireflection layer is a single layer film comprising a composition containing an organosilicon compound and inorganic oxide fine particles.

5. The plastic polarized lens as claimed in one of claims 1 to 4, wherein the polymerization composition is a thiourethane polymerization composition containing a compound having at least two mercapto groups in one molecule and a compound having at least two iso(thio)cyanate groups in one molecule.

6. The plastic polarized lens as claimed in one of claims 1 to 4, wherein the polymerization composition is a thioepoxy polymerization composition containing a compound having at least two thioepoxy groups in one molecule.
